(19) United States
(12) Patent Application Publication
(10) Pub. No.: US 2025/0103633 A1
(43) Pub. Date: Mar. 27, 2025

(54) SYSTEMS AND METHODS OF FACILITATING PROVISIONING OF INFORMATION TECHNOLOGY INFRASTRUCTURE DATA

(71) Applicant: Linvest21, Inc., Tuxedo Park, NY (US)

(72) Inventors: David Dong Lin, Tuxedo Park, NY (US); Yunfan Ma, Tuxedo Park, NY (US)

(21) Appl. No.: 18/896,368

(22) Filed: Sep. 25, 2024

Related U.S. Application Data
(60) Provisional application No. 63/585,094, filed on Sep. 25, 2023.

(51) Int. Cl. G06F 16/33; G06F 40/40

(52) U.S. Cl. CPC G06F 16/3347; G06F 40/40

(57) ABSTRACT

The present disclosure provides a method of facilitating provisioning of Information Technology infrastructure data. Further, the method may include receiving one or more IT infrastructure data infrastructures from a client device. Further, the method may include analyzing the one or more IT infrastructure data using a first Large Language Model. Further, the first LLM may be trained on a training data comprising an association of two or more IT infrastructure data and two or more IT specification data. Further, the method may include generating one or more IT specification data based on the analyzing. Further, the one or more IT specification data includes a functionality data representing one or more functionalities provided by the one or more IT infrastructures implemented according to the one or more IT specification data. Further, the method may include transmitting the one or more IT specification data to the client device.

### REFERENCE TO RELATED APPLICATIONS

This application claims the benefit of U.S. Provisional Patent Application No. 63/585,094, titled “DOMAIN-ADAPTIVE LARGE LANGUAGE MODEL FOR SPECIALIZED PLATFORM GENERATION AND MODERNIZATION”, filed Sep. 25, 2023, which is incorporated by reference herein in its entirety.

### FIELD OF DISCLOSURE

Generally, the present disclosure relates to the field of data processing. More specifically, the present disclosure relates to methods and systems for facilitating provisioning of Information Technology (IT) infrastructure data.

### BACKGROUND

The field of data processing is technologically important to several industries, business organizations, and/or individuals. Over the period of time, several technological implementations have been developed with varying degree of complexities, cost, efficiency, user-friendliness and other such parameters. As technology progresses, several of the older implementations are in need for an upgrade in order to be modernized. However, existing techniques of upgrading an IT infrastructure are fraught with severe problems. For example, most legacy systems are extremely hard to modernize owing to the lack of adequate documentation and/or skilled technicians, particularly so when it comes to reverse engineering an existing IT infrastructure in order to identify artifacts such as workflows, computation logic, software requirements and so on.

Therefore, there is a need for improved methods and systems for facilitating provisioning of Information Technology (IT) infrastructure data that may overcome one or more of the above-mentioned problems and/or limitations.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method of facilitating provisioning of Information Technology infrastructure data. Further, the method may include receiving, using a communication device, one or more IT infrastructure data associated with one or more IT infrastructures from a client device. Further, the method may include analyzing, using a processing device, the one or more IT infrastructure data using a first Large Language Model. Further, the first LLM may be trained on a training data comprising an association of two or more IT infrastructure data and two or more IT specification data. Further, the method may include generating, using the processing device, one or more IT specification data based on the analyzing. Further, the one or more IT specification data includes a functionality data representing one or more functionalities provided by the one or more IT infrastructures implemented according to the one or more IT specification data. Further, the method may include transmitting, using the communication device, the one or more IT specification data to the client device.

The present disclosure provides a system for facilitating provisioning of Information Technology infrastructure data. Further, the system may include a communication device. Further, the communication device may be configured for receiving one or more IT infrastructure data associated with one or more IT infrastructures from a client device. Further, the communication device may be configured for transmitting one or more IT specification data to the client device. Further, the system may include a processing device. Further, the processing device may be configured for analyzing the one or more infrastructure data using a first Large Language Model. Further, the first LLM may be trained on a training data comprising an association of two or more IT infrastructure data and two or more IT specification data. Further, the processing device may be configured for generating the one or more IT specification data based on the analyzing. Further, the one or more IT specification data includes a functionality data representing one or more functionalities provided by the one or more IT infrastructures implemented according to the one or more IT specification data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure.

The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating provisioning of information technology infrastructure data, in accordance with some embodiments.

FIG. 4 illustrates a flowchart of a method 400 of facilitating provisioning of information technology infrastructure data including generating, using the processing device 504, a user interface data corresponding to a user interface configured to receive indication of the training data, in accordance with some embodiments.

FIG. 5 illustrates a block diagram of a system 500 of facilitating provisioning of information technology infrastructure data, in accordance with some embodiments.

FIG. 6 illustrates a flowchart of a method 600 of facilitating provisioning of information technology infrastructure data including generating, using the processing device 504, a GUI data corresponding the GUI, in accordance with some embodiments.

FIG. 7 illustrates a flowchart of a method 700 of facilitating provisioning of information technology infrastructure data including generating, using the processing device 504, at least one computation redundancy score, in accordance with some embodiments.

FIG. 8 illustrates a flowchart of a method 800 of facilitating provisioning of information technology infrastructure data including analyzing, using the processing device 504, the at least one historical data using the first LLM, in accordance with some embodiments.

FIG. 9 is a flowchart of a method 900 for facilitating transformations of large language models for generating domain-specialized outputs, in accordance with some embodiments.

FIG. 10 is a flowchart of a method 1000 for facilitating transformations of large language models for generating domain-specialized outputs, in accordance with some embodiments.

FIG. 11 is a block diagram of a system 1100 for facilitating transformations of large language models for generating domain-specialized outputs, in accordance with some embodiments.

FIG. 12 is a flow diagram associated with a system 1200 for facilitating transformations of large language models for generating domain-specialized outputs, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performances of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for facilitating provisioning of Information Technology (IT) infrastructure data.

Further, the system encompasses a Domain-Trained Large Language Model (LLM) that autonomously learns, generates, and updates platforms tailored to specific industries. By leveraging rigorous domain-specific data ingestion, computational logic, and workflows, the LLM significantly reduces computational inefficiencies and accelerates the modernization process. The LLM's ability to continuously learn and self-optimize makes the LLM invaluable for transitioning legacy systems to modern standards while maintaining domain integrity.

Further, the following definitions and key terminologies may be associated with the system. Further, the AI model embedding comprises a deliberate process of incorporating a specifically trained AI model into a designated system, application, or another model, enabling the latter to exploit the former's capabilities within a predefined context. Further, the AI model includes data embedding. Further, the data embedding includes the methodical transformation of distinct data types, such as words or images, into vector representations in a predetermined high-dimensional space, ensuring that semantically similar data converge in the high-dimensional space. Further, Model Integration may include a systematic process of integrating a pre-defined AI model's architecture and specific parameters into a target system. Model Integration often involves transitioning the model into a specific deployment format followed by its integration. Further, Transfer Learning may include a strategic process where the representations learned by a primary model serve as the foundational knowledge for a secondary task or model. Further, Functional Integration may include the seamless amalgamation of the AI model's capabilities with select system components, ensuring the preservation of system performance and real-time responsiveness. Further, Prompt Model may be described within the AI domain, and particularly for Large Language Models (LLMs). A “prompt model” represents a structured methodology that directs users on how to interact or command the LLM, guaranteeing that the model's output is in strict accordance with predefined requirements. Further, the Domain-Specific Prompting may include the tailored creation and utilization of prompts specifically designed to extract or generate content, or initiate tasks, in alignment with established industry standards and terminologies. Further, the LLM Fine-tuning may include a specialized adaptation process in which a pre-trained model, initially designed on a comprehensive dataset, undergoes further training on a curated, domain-specific dataset. The fine-tuning is essential when there's limited labeled data and is characterized by industry fine-tuning, wherein the targeted adaptation of a base model using industry-specific literature or datasets, refining the LLM for tasks related to sectors such as healthcare or finance.

Further, the present disclosure describes methods and systems for facilitating transformations of large language models for generating domain-specialized outputs. Further, the disclosed system may be configured for domain-fine tuning LLMs as the domain products with the ability to reverse-engineer and auto-integrate with the end client's technology ecosystem. Further, the system relates to the field of artificial general intelligence, specifically to the fine-tuning of large language models for domain-specific applications and the LLM's integration with end-client technology ecosystems.

Further, the LLMs may be initially pre-trained on a broad spectrum of data. Subsequent fine-tuning is performed using domain-specific data, focusing on business concepts relevant to the specific domain. The fine tuning process includes data, computational logic, workflow, and associated codes.

Further, the LLM provider may collaborate with end clients. The end client's data assets, which encompass data definitions and content, along with software assets detailing service definitions in code for computational logics and workflows, may be supplied to the LLMs. Using the acquired domain knowledge, the LLM may then reverse-engineer, integrate, and encapsulate the knowledge of the end client's data, computation, and workflow. Upon successful encapsulation of the knowledge of data and computation logics and workflows within the LLMs, the product provider then establishes a callable API or interface. The API allows external services to request and leverage the capabilities of the LLMs. To ensure the LLMs remain updated and effective, the LLM's undergo continuous training and fine-tuning. The ongoing adaptation integrates new data, computational logic, and workflows, allowing the LLMs to stay current and relevant.

Further, the system offers several advantages. Further, Legacy technologies, regardless of age, may be swiftly transitioned to the latest technological standards and solutions. Further, there's an opportunity to consolidate, rationalize, and optimize all data and services within any end-client technological ecosystem. Further, the system introduces intelligence to a firm's tech offerings, ensuring agility, scalability, correctness, and innovation.

Further, the end-client data assets and software assets may be integrated into the LLM, highlighting the centralized knowledge repository. The LLM is central, emphasizing the creation of an API or interface for external service access. Further, the continuous input of new data and logic into the LLM, emphasizes the LLM's dynamic and evolving nature.

Further, the system may be rooted in the domain of artificial general intelligence. Further, the system delineates the transformation process of large language models (LLMs) when the LLM's may be adapted with domain-specific data, enabling the LLM's to function as specialized domain products.

Further, the nature of domain-trained LLMs “domain-trained” signifies the LLM's enhancement process which includes the LLM's initial extensive data training, followed by domain-specific fine-tuning. Further refinement occurs through the embedding of domain-specific knowledge and implementing specialized prompts to ensure domain-centric outputs. Further, the LLMs as Domain Products, commonly utilized for various data processing tasks may be specially tailored through domain-specific training. The adaptation equips the LLM's to manage unique challenges and tasks within a particular domain, thereby serving as domain products. Further, the transformation process comprises an assimilation process. Further, the product is designed to thoroughly understand and assimilate the end client's technological framework. Through procedures of reverse engineering, internalization, and codification, the product integrates the client's data structures, computational logic, and workflows ensuring a holistic representation of the client's technological assets within the LLM. Further, the transformation process may include application of the End-Client-Knowledgebase. Further, upon assimilation, the enriched LLM serves as a comprehensive toolset, capable of either crafting new technological platforms or enhancing and modernizing existing infrastructures. The enriched LLM streamlines and upgrades client tech assets. Further, the transformation process may include continuous evolution and benefits of the system.

Further, the continuous evaluation may include feedback-driven refinement. Further, the LLMs, being adaptive by design, continually evolve. As end-clients interact and provide feedback, the LLM integrates the feedback, further refining its responses and strategies ensuring the LLM remains aligned with user needs and industry developments. Further, the continuous evaluation may include rapid transitioning. Further, legacy technologies, irrespective of inception, may seamlessly adapt to contemporary technological standards, thanks to the capabilities introduced by the domain-trained LLM. Further, the continuous evaluation may include ecosystem optimization. Further, the LLMs provide a consolidated platform for rationalizing and enhancing all data and services within an end-client technological framework. Further, the continuous evaluation may include augmented Intelligence. Further, the LLMs introduce advanced intelligence, bolstering a firm's tech offerings and enhancing attributes like agility, scalability, precision, and innovation.

Further, the disclosed methods may include rigorous training, embedding, and prompting, culminating in LLMs that may autonomously generate domain-specific solutions with precision. The presented system holds paramount significance for industries such as finance, healthcare, enterprise software modernization, and other sectors that may be deeply intertwined with legacy systems and necessitate acute domain knowledge.

Further, the presented system underscores the domain-trained LLM as both the foundational platform and the solution to domain-specific challenges. By meticulously tailoring the LLM to specialized industry contexts, the methodology refines the precision and applicability of AI-driven solutions to cater to distinct industry nuances. Further, the highlights of the system may include a Domain-Trained LLM as the Core Platform. Further, at the center of the system, the Domain-trained LLM emerges as a specialized platform specifically crafted for industries like finance, healthcare, and enterprise software modernization. Further, the highlights of the system may include in-depth domain-training techniques. Further, these techniques may be integral to ensuring the LLM's alignment with industry intricacies. Further, these techniques may include Domain-Specific Prompting. Further, tailored prompts may be meticulously designed to resonate with and extract industry-specific knowledge. Further, these techniques may provide contextual interpretation according to which domain-specific training enables the system to interpret data and queries in the correct context of the industry, reducing misunderstandings and errors that might occur with a general-purpose AI. Further, these techniques may include embedding techniques. Further, custom methods may be developed to convert domain-specific data into accurate vector representations, ensuring higher fidelity. Further, these techniques may include fine-tuning protocols. Further, these techniques may include iterative refinement processes that leverage domain expertise, enabling the LLM to continually hone the understanding. Further, the highlights of the system may include End-Client Centricity. Further, beyond generic solutions, the Domain-trained LLM platform is designed to internalize and operate within an end-client's unique technological and industry landscape, thereby delivering highly targeted solutions. Further, the highlights of the system may include dynamic learning mechanisms. Further, the domain-trained LLM platform is equipped with data assimilation. Further, the data assimilation comprises the real-time capability to gather and synthesize domain-specific data. Further, the domain-trained LLM platform is equipped with iterative feedback loops. Further, the iterative feedback loops may include self-adapting mechanisms informed by user interactions and industry evolution. Further, the Domain-trained LLM platform is equipped with self-optimization. Further, the self-optimization may be a built-in capability for introspection and continuous improvement. Further, the highlights of the system may include legacy modernization. Further, the Domain-trained LLM platform is distinguished by its proficiency in facilitating a seamless transition from outdated legacy systems, ensuring alignment with contemporary technological standards. Further, the highlights of the system may include efficacy metrics. Further, the preliminary evaluation may include computational efficiency. Further, with the system's precision in generating domain-specific solutions, the Domain-trained LLM platform anticipates a reduction in computational redundancy by approximately 400%. Further, the precision stems from its ability to minimize iterative computations, thereby significantly curtailing computational waste. Further, the preliminary evaluations may include modernization velocity. Further, the expertise of the Domain-trained LLM in rapidly comprehending and adapting to the intricacies of legacy systems results in a projected acceleration in modernization processes by over 200%. The boost is attributed to the LLM's capability to quickly translate legacy complexities into modern solutions, reducing the typical duration and resources required for such transitions. Further, the highlights of the system may include sustained relevance. Further, uniquely engineered for adaptability, the Domain-trained LLM platform is geared to ensure consistent alignment with the evolving challenges and standards of various industries.

Further, at the core of the system is the ‘Domain-Trained LLM’, distinguishing itself from generic AI models by its ability to internalize and codify industry-specific assets. The system equips the LLM with the unique capability to autonomously reverse engineer, internalize, and codify a client's technological assets. The result is an LLM that not only understands the language and nuances of a specific industry but is also adept at navigating unique challenges, workflows, and intricacies.

Further, unlike many AI models designed for generic tasks, Domain-Trained LLMs represent a meticulous transformation. The LLM's evolve from broad capabilities to become specialized domain experts. The evolution equips the LLM's with a profound understanding tailored to specific industry domains, much like a general physician advancing to a cardiologist. Such specialization ensures comprehension of industry-specific language, challenges, workflows, and intricacies, offering precise solutions more efficiently than one-size-fits-all models.

Further, deploying Domain-Trained LLMs involves specialized training and productization to suit industry contexts. Further, the process encompasses several pivotal steps. Further, the system may include Data Training Domain-Specific Data Ingestion. Further, beyond merely feeding the LLM with domain data, the unique approach ensures that the data is curated, cleaned, and structured to resonate with the specific nuances of the industry. Including leveraging proprietary algorithms to identify and prioritize high-value data segments. Further, the system may include security protocols. Further, special emphasis is given to understanding system security elements, such as authentication and authorization protocols. Further, the process includes specialized security module training, ensuring that the LLM respects and enforces security boundaries. Further, the system may include Computational Logics and Workflows Training. Further, the multi-stage process includes: curating computational logic data. The method goes beyond mere data gathering. Further, specialized tools may be used to dissect and interpret the inherent computational logic of specific domains, ensuring the LLM grasps the underlying principles. Further, the system may include Embedding Techniques. Further, while many systems use generic embedding methods, the system has developed proprietary techniques tailored for complex domain data, ensuring higher fidelity in vector representations. Further, the system may include Fine-Tuning Protocols. Further, the fine-tuning process is not just about adapting the LLM to domain-specific datasets. The system has introduced iterative feedback loops, leveraging domain expert insights to refine the LLM's understanding continuously. Further, the system may include establishing a stable interaction language. Further, beyond just formulating a consistent interaction language, the approach ensures that the language evolves, incorporating user feedback and industry changes, making sure the LLM's outputs may always be in line with the latest industry standards.

Further, by religiously adhering to these refined steps, the Domain-Trained LLM emerges as a system that is not only deeply knowledgeable about specific industries but also upholds the highest standards of security, efficiency, and adaptability.

Further, the system's cornerstone is its unique prompt language designed specifically for Domain-Trained LLMs. Unlike generic AI prompts, the language resonates with specific industry domains. Further, the language ensures consistent, reliable, and domain-specific LLM outputs. Further, by immersing LLMs in domain-centric data and complementing the LLM's with the unique prompt language, the system is aligned to industry challenges, ensuring precise interactions.

Further, building on the unique prompt language and domain-specific training, preliminary simulations suggest significant enhancements in computational efficiency and modernization speeds. These simulations indicate potential reductions in computational waste by approximately 400% and an acceleration in modernization processes by over 200%, essential to underscore that these metrics while promising, may be derived from initial tests and simulations. The exact outcomes may be contingent upon real-world applications, the specifics of the domain, and the nature of the legacy systems being modernized. For example, the disclosed techniques provide targeted processing according to which, the Domain-Trained LLM being specifically tailored to the industry and client needs entails that the system doesn't waste computational resources on irrelevant or generic tasks, focusing instead on domain-specific operations. As another example, the disclosed techniques provide streamlined decision-making according to which the domain-specific knowledge embedded in the system allows for more direct and efficient decision-making processes, reducing the computational overhead often associated with navigating complex, industry-specific problems. As yet another example, the disclosed techniques provide optimized prompting according to which the unique prompt language developed for this system ensures that interactions are more precise and efficient, potentially reducing the number of computational cycles needed to arrive at accurate outputs.

Further, transitioning from the foundational concepts to real-world applications, it's imperative to highlight the transformative potential of the Domain-Trained Large Language Model. The section underscores the practical implications, showcasing how the meticulously crafted system seamlessly addresses diverse industry challenges.

Further, imagine a global banking enterprise that grapples with the challenge of consolidating diverse financial data from its legacy systems, each developed during different technological epochs. Through the Domain-Trained LLM, armed with its unique prompt language, the bank may seamlessly query data across these systems, translating high-level inquiries into actionable insights without manual data wrangling. In another scenario, consider a healthcare provider aiming to unify patient data scattered across multiple platforms. The LLM, with its industry-specific training, may autonomously reverse-engineer data structures, workflows, and computational logic, ensuring that medical professionals receive consolidated patient insights in real-time. These scenarios exemplify the transformative potential of the system, not as mere theoretical constructs but as tangible solutions addressing pressing industry challenges.

Further, the contemporary market, while teeming with AI-driven solutions, often lacks models that may seamlessly adapt to domain-specific requirements, especially in industries burdened by legacy systems. There exists a pressing gap for tools that might both understand and transform these systems, capturing the industry's nuances without sacrificing efficiency or precision.

Further, following technical gaps may be addressed by the Domain-Trained LLM. Further, the technical gaps addressed may include Precision in Domain Adaptation. Further, most AI solutions, while robust, often fail to capture the intricate nuances of specific industries. The Domain-Trained LLM, through its meticulous adaptation process, ensures high fidelity in understanding and addressing domain-specific challenges. Further, the technical gaps addressed may include Efficient Transitioning of Legacy Systems. Further, the technological landscape may be riddled with legacy systems that resist modernization. The Domain-Trained LLM's unique capability allows for a smoother transition from these legacy systems to contemporary standards without a massive overhaul. Further, the technical gaps addressed may include Dynamic Learning and Adaptation. Further, many AI models stagnate after initial training. In contrast, the LLM's architecture promotes continuous learning, ensuring the LLM remains relevant as industries evolve.

Further, following technical advantages may be offered. Further, the technical advantages may include Domain-Specific Intelligence Augmentation. Further, by integrating rigorous training and adaptation methodologies, the resulting Domain-Specific LLM emerges as a tailored, knowledge-rich entity. The resulting Domain-Specific LLM may translate domain-specific terminologies, workflows, and intricacies into actionable insights. Further, the technical advantages may include Technological Modernization. Further, the Domain-Trained LLM stands as a beacon of technological advancement, allowing for the creation of solutions optimized for domain accuracy at an accelerated pace. Further, the technical advantages may include Iterative and Autonomous Learning. Further, the LLM's inherent capability for feedback-driven refinement means the LLM's doesn't just adapt to the present but evolves for the future, ensuring sustainable relevance. Further, by addressing these market gaps and offering distinct technical advantages, the Domain-Trained LLM is not only a testament to innovation but also a direct answer to the pressing challenges faced by industries today.

Further, the system may include a challenge associated with data privacy. Further, with the extensive training and assimilation processes the Domain-Trained LLMs undergo, there's a significant amount of data being fed into the system raising concerns about the security and privacy of sensitive data, especially when dealing with sectors like healthcare and finance Further a Scenario 1 is considered for Hosting LLM at Client Site or Client-Owned Cloud Facilities. Further, in situations where the LLM is hosted on-premises or in cloud environments owned by the client, data privacy concerns may be somewhat alleviated. The training data remains within the realm of the end client's firewalled environment, ensuring an added layer of security. However, even in these settings, it's essential to implement strict access controls and monitoring mechanisms to prevent any unauthorized access or potential data breaches. Further, a scenario 2 is considered for Hosting LLM at Vendor Site or Cloud Facility. Further, when the LLM is hosted externally, implementing stringent data encryption and anonymization techniques becomes paramount to safeguard sensitive information. Moreover, the LLM may be trained to recognize and handle private data with special care, ensuring the LLM may never get exposed or misused. Regular audits, compliance checks with data protection regulations (like GDPR or HIPAA), and adherence to best practices in cloud security may further bolster data privacy and security in these setups.

Further, the system poses a challenge associated with scalability. Further the challenge may include as businesses grow and evolve, the businesses technological needs may change dramatically. The ability of the Domain-Trained LLMs to scale and adapt to increasing data volumes and complexity is crucial for long-term viability. Further, the solution may include by designing the LLMs with modularity and cloud-based architectures in mind, scalability may be inherently built into the system ensuring that as the data or user base grows, the LLM may seamlessly handle the increased load. Additionally, continuous feedback-driven refinement may help the LLM adapt to changing business dynamics, ensuring it remains relevant and efficient.

Further, the system poses a challenge associated with integration with diverse systems. Further, the challenge may include enterprises often operating with a multitude of systems, developed across different technological epochs. Integrating the Domain-Trained LLMs with such diverse systems, without disrupting existing workflows, may be a daunting task. Further, the solution may include leveraging API-driven architectures that may facilitate smoother integrations. The LLM may be designed to communicate via standardized APIs, ensuring the LLM may interface with a wide range of systems. Furthermore, the LLM's capability to autonomously reverse-engineer data structures and computational logic may aid in understanding and integrating with legacy systems. Regularly updating integration protocols and ensuring compatibility checks may further smoothen the integration process. Further, in the domain of artificial general intelligence, differentiation is paramount. The system systematically integrates a Domain-Specific Prompt Model, Embedding Model, and the Large Language Model (LLM).

Further, the system may be predicated on three intertwined components. Further, the system may include The Domain-Specific Prompt Model, the Embedding Model, and the LLM.

Further, the functionality may include these interconnected components granting the system the unique capability to autonomously assimilate knowledge from end-client technological assets and environments, making legacy platform modernization feasible.

Further, the current AI landscape showcases a plethora of systems broadly labeled as “AI Coders”. However, a deeper exploration reveals stark differences between the system and these generalized systems. Further, many existing systems function primarily as Code Assistance tools, aiding engineers in completing code snippets but not understanding the broader application or domain. Further, several others may be designed for small-scale projects, limited to managing 1 to 20 files. The scope and depth may be considerably restricted. Further, critically, these systems lack Domain Knowledge. They operate as generic assistants without the depth or breadth to comprehend industry-specific nuances. Further, the concepts of Domain Specific Prompting, Embedding, and LLM Fine-tuning may be largely absent in these systems. These elements may be central to the system and epitomize its adaptability and precision.

Further, with its specialized approach and clear differentiation from “AI Coder” systems, the system carves out a distinct niche in the AI field, focusing on adaptive solutions tailored to end-client needs and industry nuances. Further, the framework underscores the innovation and unique positioning of the system within the AI sector, emphasizing its forward-thinking design and comprehensive capabilities.

Further, at the heart of the system is the autonomous capability of the Domain-Trained LLM to continuously learn, adapt, and refine its knowledge base. Unlike standard Large Language Models which primarily rely on static training data, the Domain-Trained LLM engages the Dynamic Data Assimilation. Further, the LLM is designed to ingest and understand new domain-specific data in real-time. The constant data assimilation ensures that the LLM's knowledge remains current and relevant. Further, the Domain-Trained LLM engages the Iterative Feedback Loop. Further, the LLM autonomously adapts based on user interactions, system feedback, and evolving industry trends allowing the LLM to refine its responses and improve accuracy over time. Further, the Domain-Trained LLM engages the Self-Optimization. Further, leveraging advanced AI techniques, the LLM autonomously identifies areas of improvement, optimizing its internal processes without manual intervention. By integrating these autonomous learning features, the Domain-Trained LLM transcends the limitations of traditional LLMs, ensuring it remains at the forefront of domain-specific knowledge and application.

Further, The Domain-Trained LLM's autonomous learning capabilities culminate in its application phase, where it employs its enriched knowledge base to address real-world industry challenges. Further, the challenges addressed may include Client-Specific Adaptation. Further, unlike standard LLMs that offer generic solutions, the Domain-Trained LLM tailors its responses based on a deep understanding of the end client's unique technological landscape. Further, the understanding may be achieved through rigorous training on client-specific data, computational logic, workflows, and historical issues. Further, the challenges addressed may include Dynamic Response Generation. Further, the LLM's deep domain-centric training, combined with its unique prompt language, enables it to generate responses that may not only be accurate but also resonate with industry-specific terminologies and nuances. Further, the challenges addressed may include Continuous Evolution. Further, the LLM is designed to evolve with the client's ever-changing technological needs. As the industry landscape shifts, the LLM autonomously updates its knowledge base, ensuring its solutions remain relevant and robust.

Further, in essence, the Domain-Trained LLM's autonomous capabilities ensure that it doesn't just understand the client's current needs but also anticipates and evolves to meet future challenges, distinguishing it from traditional LLMs.

Further, The Domain-Trained LLM, engineered with state-of-the-art techniques in artificial general intelligence, offers a progressive approach to address domain-specific challenges. The LLM's design emphasizes continuous learning and adaptation, which culminates in tangible technical benefits. Further, the benefits may include Feedback-Driven Refinement. Further, the LLM's architecture may be structured to assimilate user feedback and system interactions in real time. Further, the dynamic feedback loop ensures that the LLM remains constantly updated and aligned with evolving industry standards. Further, the benefits may include Rapid Transitioning. Further, specialized training, embedding, and prompting techniques enable the Domain-Trained LLM to swiftly understand legacy system data and workflows. Further, the LLMs proficiency allows for a seamless transition from antiquated systems to contemporary standards, bridging the gap between old and new without massive overhauls. Further, the benefits may include Ecosystem Optimization. Further, deep domain-centric training ensures the LLM's comprehension of industry-specific language, challenges, and intricacies. Further, as a unified platform, the LLM may holistically optimize various facets of an enterprise's technological ecosystem, offering solutions that resonate with domain-specific needs. Further, the benefits may include Augmented Intelligence. Further, the Domain-Trained LLM's unique prompt language and rigorous adaptation processes guarantee outputs that align with domain-specific terminologies. Further, the advanced intelligence amplifies an organization's technological capabilities, enabling the organizations to address challenges with heightened precision and efficiency. Further, each of these benefits, rooted in the technical foundations of the Domain-Trained LLM, showcases the direct correlation between the model's unique features and its potential advantages in real-world applications.

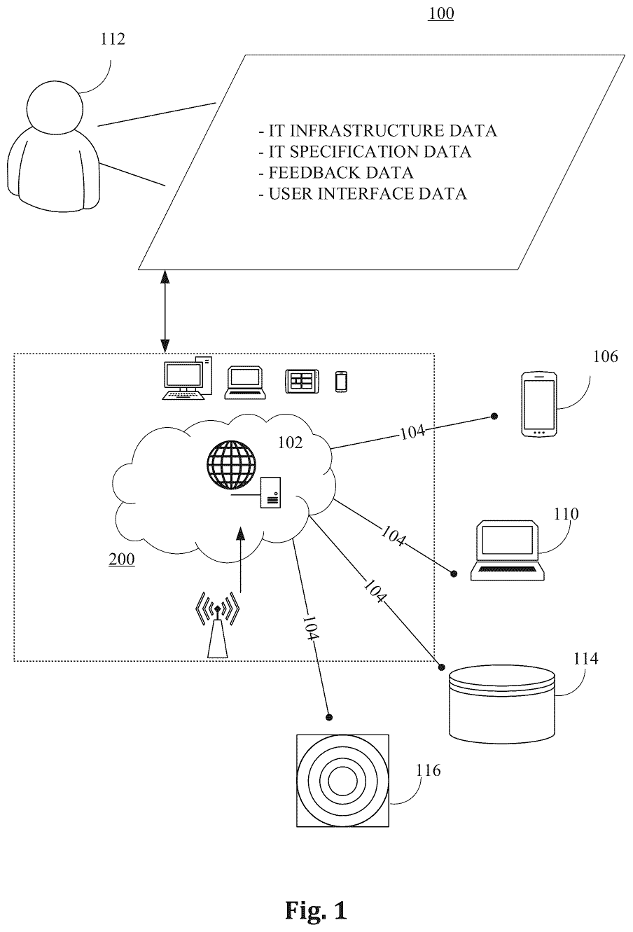

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

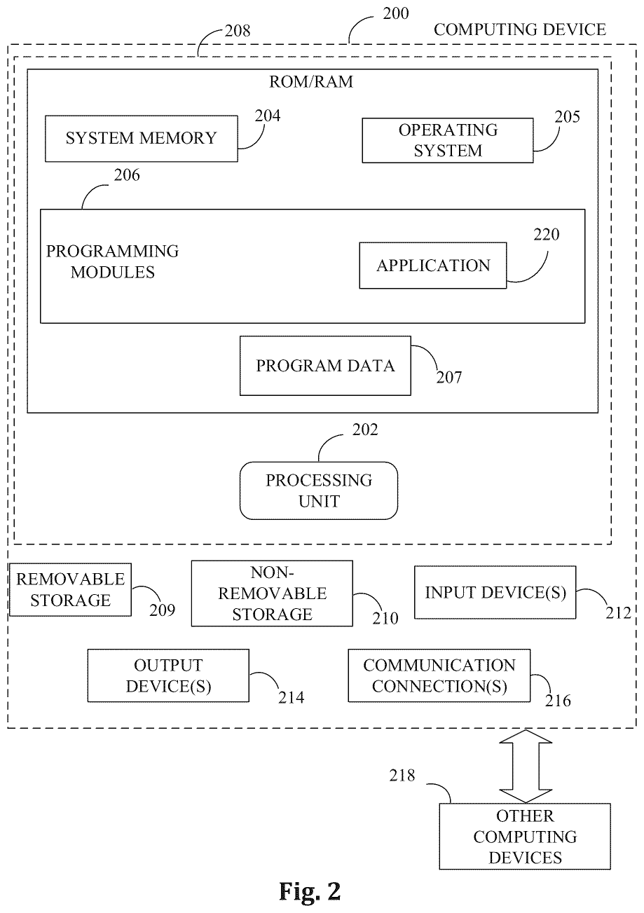

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

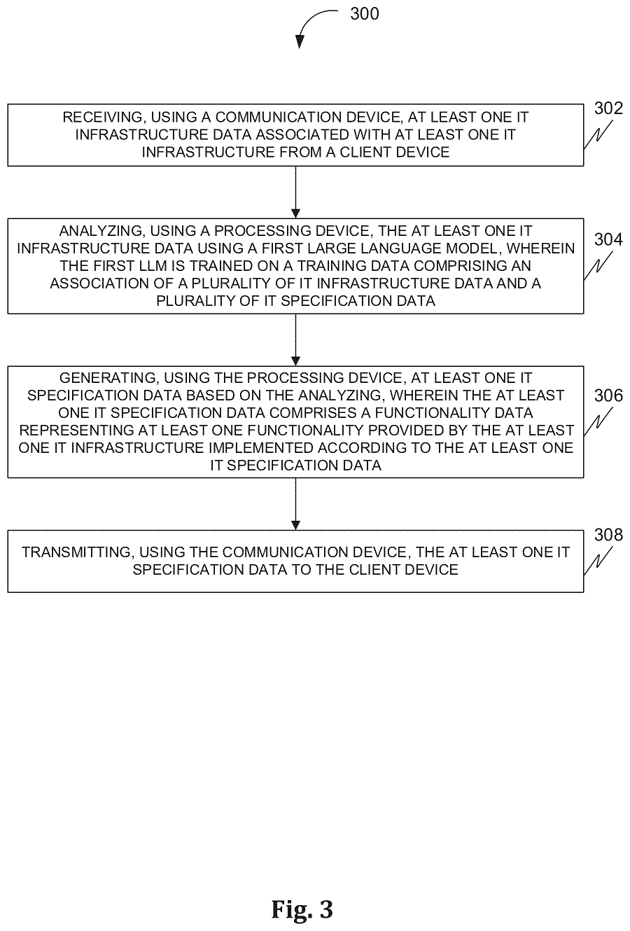

FIG. 3 illustrates a flowchart of a method 300 of facilitating provisioning of information technology infrastructure data, in accordance with some embodiments.

Accordingly, the method 300 may include a step 302 of receiving, using a communication device 502, one or more IT infrastructure data associated with one or more IT infrastructures from a client device. Further, the method 300 may include a step 304 of analyzing, using a processing device 504, the one or more IT infrastructure data using a first Large Language Model. Further, the first LLM may be trained on a training data comprising an association of two or more IT infrastructure data and two or more IT specification data. Further, the method 300 may include a step 306 of generating, using the processing device 504, one or more IT specification data based on the analyzing. Further, the one or more IT specification data includes a functionality data representing one or more functionalities provided by the one or more IT infrastructures implemented according to the one or more IT specification data. Further, the method 300 may include a step 308 of transmitting, using the communication device 502, the one or more IT specification data to the client device.

In some embodiments, the method 300 may further include generating, using the processing device 504, an updated IT infrastructure data based on the one or more IT specification data. Further, the generating of the updated IT infrastructure data may be performed using a second LLM. Additionally, in some embodiments, the generating of the updated IT infrastructure data may be further based on a compliance data. Further, in some embodiments, the method 300 may include a step of generating, using the processing device, the compliance data based on the at least one infrastructure data. Consequently, in some embodiments, the updated IT infrastructure may be in compliance with the same regulation as the at least one infrastructure, such as, for example, a legacy system. Accordingly, the disclosed methods and systems enable modernization of IT infrastructure while maintaining compliance relating to technical aspects (e.g. engineering standards) and/or non-technical aspects (regulatory compliance, privacy restrictions etc.).

In some embodiments, the method 300 may further include training, using the processing device 504, the first LLM based on the training data.

In some embodiments, the training data includes one or more of a concept data, a workflow data and a computational logic data.

In some embodiments, the training data corresponds to a domain.

In some embodiments, the method 300 may further include deploying, using the processing device 504, an updated IT infrastructure based on the updated IT infrastructure data.

In some embodiments, the method 300 may further include receiving, using the communication device 502, one or more feedback data from the client device. Further, the feedback data includes one or more feedbacks based on the one or more IT specification data. Further, the analyzing of the one or more IT infrastructure data may be based on the training of the first LLM using the one or more feedback data.

In some embodiments, the training of the first LLM includes embedding one or more vector representations of one or more of the concept data, the computational logic data and the workflow data into a model architecture of the first large language model.

In some embodiments, the training further includes fine-tuning of the first LLM based on the embedding.

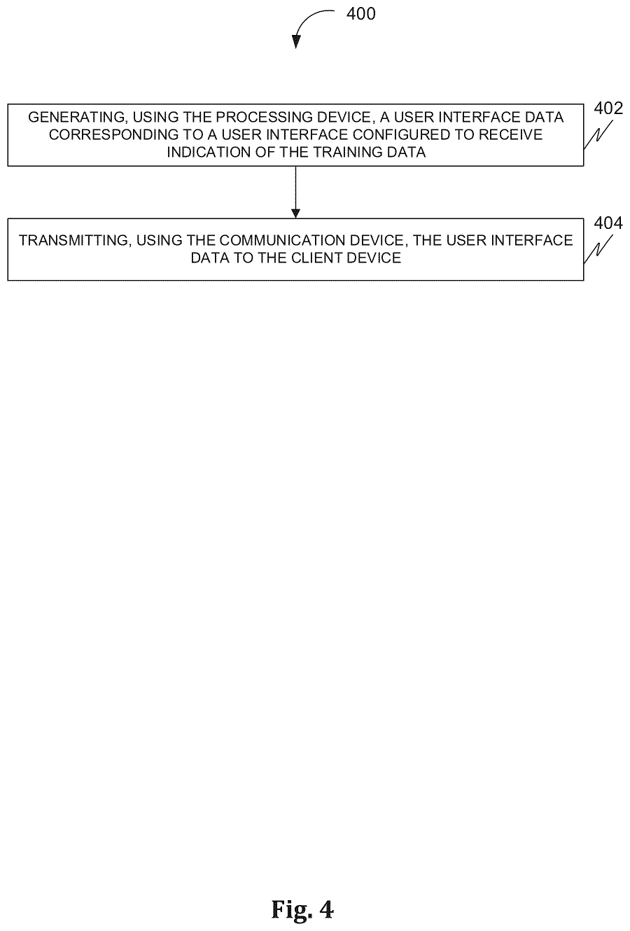

FIG. 4 illustrates a flowchart of a method 400 of facilitating provisioning of information technology infrastructure data including generating, using the processing device 504, a user interface data corresponding to a user interface configured to receive indication of the training data, in accordance with some embodiments.

Further, in some embodiments, the training data corresponds to a domain. Further, the method 400 further may include a step 402 of generating, using the processing device 504, a user interface data corresponding to a user interface which may be configured to receive indication of the training data. Further, the method 400 further may include a step 404 of transmitting, using the communication device 502, the user interface data to the client device.

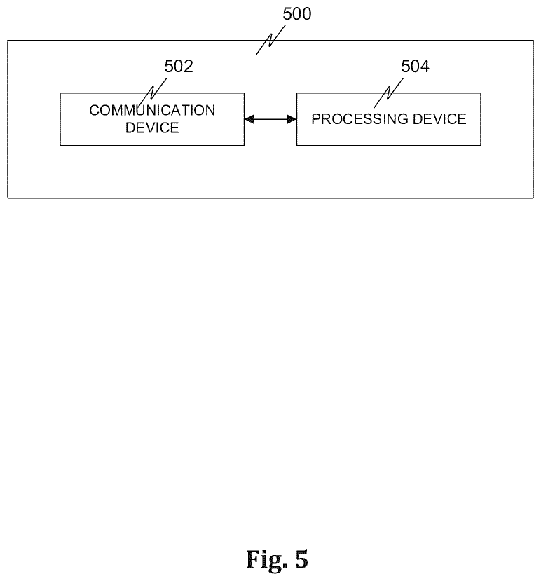

FIG. 5 illustrates a block diagram of a system 500 of facilitating provisioning of information technology infrastructure data, in accordance with some embodiments.

Accordingly, the system 500 may include a communication device 502. Further, the communication device 502 may be configured for receiving one or more IT infrastructure data associated with one or more IT infrastructures from a client device. Further, the communication device 502 may be configured for transmitting one or more IT specification data to the client device. Further, the system 500 may include a processing device 504. Further, the processing device 504 may be configured for analyzing the one or more infrastructure data using a first Large Language Model. Further, the first LLM may be trained on a training data comprising an association of two or more IT infrastructure data and two or more IT specification data. Further, the processing device 504 may be configured for generating the one or more IT specification data based on the analyzing. Further, the one or more IT specification data includes a functionality data representing one or more functionalities provided by the one or more IT infrastructures implemented according to the one or more IT specification data.

In some embodiments, the processing device 504 may be further configured for generating an updated IT infrastructure data based on the one or more IT specification data using a second LLM.

In some embodiments, the processing device 504 may be further configured for training the first LLM based on the training data.

In some embodiments, the training data includes one or more of a concept data, a workflow data and a computational logic data.

In some embodiments, the training data corresponds to a domain.

In some embodiments, the processing device 504 may be further configured for deploying an updated IT infrastructure based on the updated IT infrastructure data.

In some embodiments, the communication device 502 may be further configured for receiving one or more feedback data from the client device. Further, the feedback data includes one or more feedbacks based on the one or more IT specification data. Further, the analyzing of the one or more IT infrastructure data may be based on the training of the first LLM using the one or more feedback data.

In some embodiments, the training of the first LLM includes embedding one or more vector representations of one or more of the concept data, the computational logic data and the workflow data into a model architecture of the first large language model.

In some embodiments, the training further includes fine-tuning of the first LLM based on the embedding.

In some embodiments, the training data corresponds to a domain. Further, the processing device 504 may be further configured for generating a user interface data corresponding to a user interface which may be configured to receive indication of the training data. Further, the communication device 502 may be further configured for transmitting the user interface data to the client device.

In some embodiments, the generating of the updated infrastructure data corresponds to a modernization operation of the one or more IT infrastructures comprising a legacy IT infrastructure.

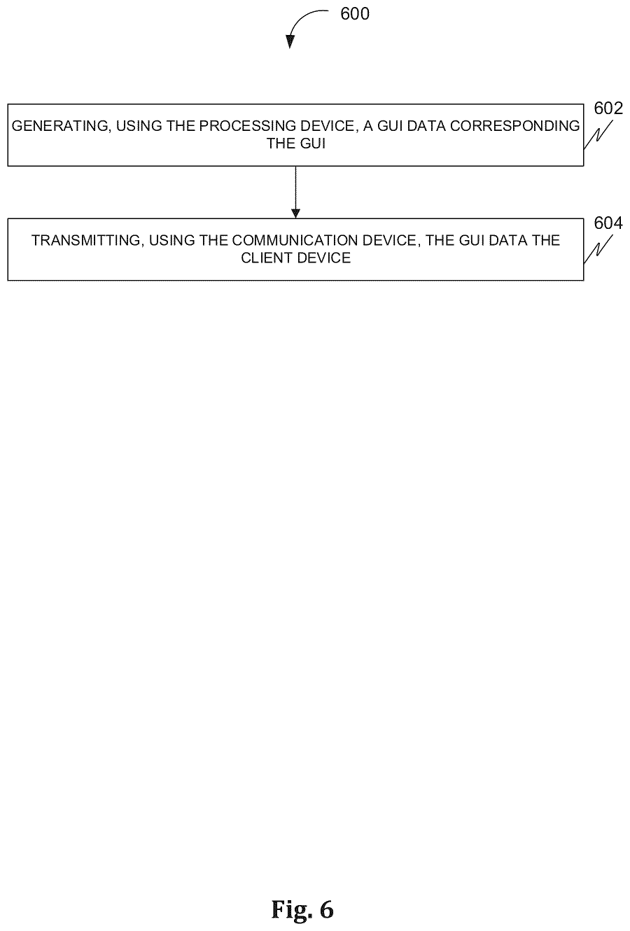

FIG. 6 illustrates a flowchart of a method 600 of facilitating provisioning of information technology infrastructure data including generating, using the processing device 504, a GUI data corresponding the GUI, in accordance with some embodiments.

Further, in some embodiments, the each of the receiving of the one or more IT infrastructure data and presentation of the one or more IT specification data may be facilitated by one or more service layers may include a GUI. Further, the method 600 further may include a step 602 of generating, using the processing device 504, a GUI data corresponding the GUI. Further, the method 600 further may include a step 604 of transmitting, using the communication device 502, the GUI may data the client device.

In some embodiments, the concept data corresponds to one or more concepts.

In some embodiments, the one or more concepts correspond to a use-case scenario associated with the one or more functionalities.

In some embodiments, the domain corresponds to one or more of a financial field, a healthcare field and an enterprise field.

In some embodiments, the computational logic data corresponds to one or more computational algorithms. Further, the one or more computational algorithms includes a format conversion algorithm, an OCR algorithm and a handwriting recognition algorithm.

In some embodiments, the workflow data corresponds to one or more workflows comprising one or more of a login action, a login-authentication action and a medical document uploading action.

In some embodiments, the one or more concepts include a medical data of a patient. Further, the medical data includes a general data, a vital data and a medical history data.

In some embodiments, the one or more functionalities includes updating an electronic health record based on the medical document uploading action.

In some embodiments, the updating of the electronic health record may be based on a format conversion of a medical document.

In some embodiments, the use-case scenario includes one or more actions. Further, the one or more actions includes uploading a medical document on an online server by one or more healthcare professionals, extracting a prescription data from the medical document and transforming the prescription data into an electronic health record.

In some embodiments, the first LLM includes a pre-trained LLM.

In some embodiments, training of the first LLM includes fine-tuning.

In some embodiments, the fine-tuning of the first LLM may be based on at least one of a concept data, a computational logic data, a workflow data.

In some embodiments, each of the concept data, the computational logic data and the workflow data corresponds to a domain.

In some embodiments, the training may be performed continuously.

In some embodiments, the training may be based on self-learning.

In some embodiments, the training data further includes a Meta data corresponding to one or more of the concept data, the workflow data and the computational logic data. Further, the Meta data represents one or more properties associated with one or more of the concept data, the workflow data and the computational logic data. Further, each of the concept data, the workflow data and the computational logic data corresponds to a domain.

In some embodiments, the training data includes end client domain assets.

In some embodiments, the end client domain assets includes a Meta data, a data content, a computational logic data and the workflow data.

In some embodiments, one or more of the computational logic data and the workflow data may be comprised in a code.

In some embodiments, the end client domain assets corresponds to one or more domains.

In some embodiments, the method 300 may further include receiving, using the communication device 502, one or more feedback data from the client device. Further, the feedback data includes one or more feedbacks based on the one or more IT specification data. Further, the training may be based on the one or more feedback data.

In some embodiments, the training may be performed in real-time.

In some embodiments, the user interface data may be further configured for receiving indication of one or more evaluation scores of the training of the first LLM. Further, the one or more evaluation scores may be based on one or more evaluation metrics. Further, the method 400 further includes validating, using the processing device 504, the IT specification data based on the one or more evaluation metrics. Further, the one or more evaluation metrics represents a correctness of an association between the IT specification data associated with the one or more IT infrastructure data.

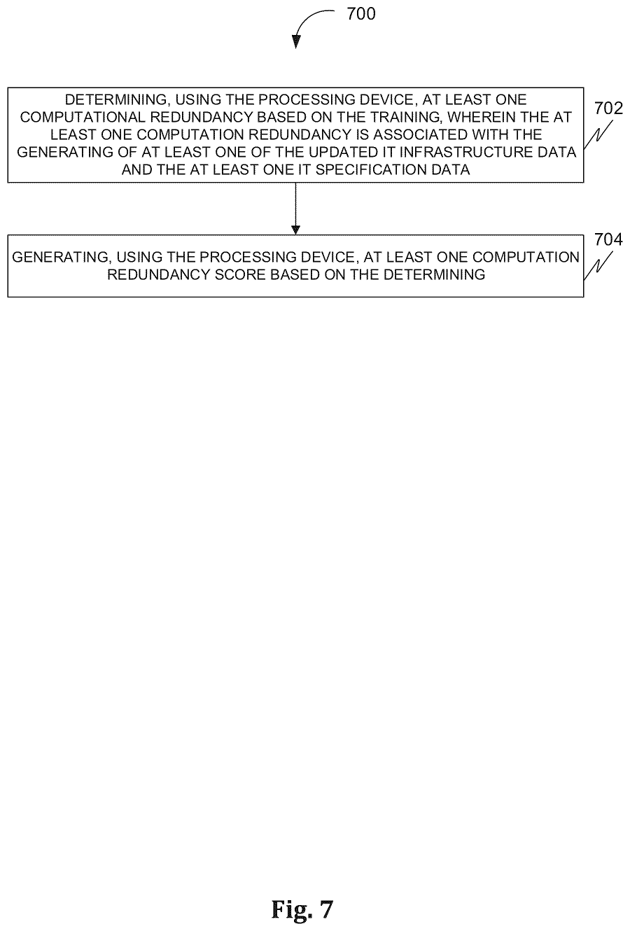

FIG. 7 illustrates a flowchart of a method 700 of facilitating provisioning of information technology infrastructure data including generating, using the processing device 504, at least one computation redundancy score, in accordance with some embodiments.

Further, in some embodiments, the method 700, further may include a step 702 of determining, using the processing device 504, one or more computational redundancies based on the training. Further, the one or more computation redundancies may be associated with the generating of one or more of the updated IT infrastructure data and the one or more IT specification data. Further, in some embodiments, the method 700, further may include a step 704 of generating, using the processing device 504, one or more computation redundancy scores based on the determining.

In some embodiments, the one or more IT infrastructures includes a cloud infrastructure. Further, the cloud infrastructure may be associated with a cloud service.

In some embodiments, the user interface may be further configured to present one or more utilization data associated with a utilization of the processing device 504 during one or more sessions of training the first LLM.

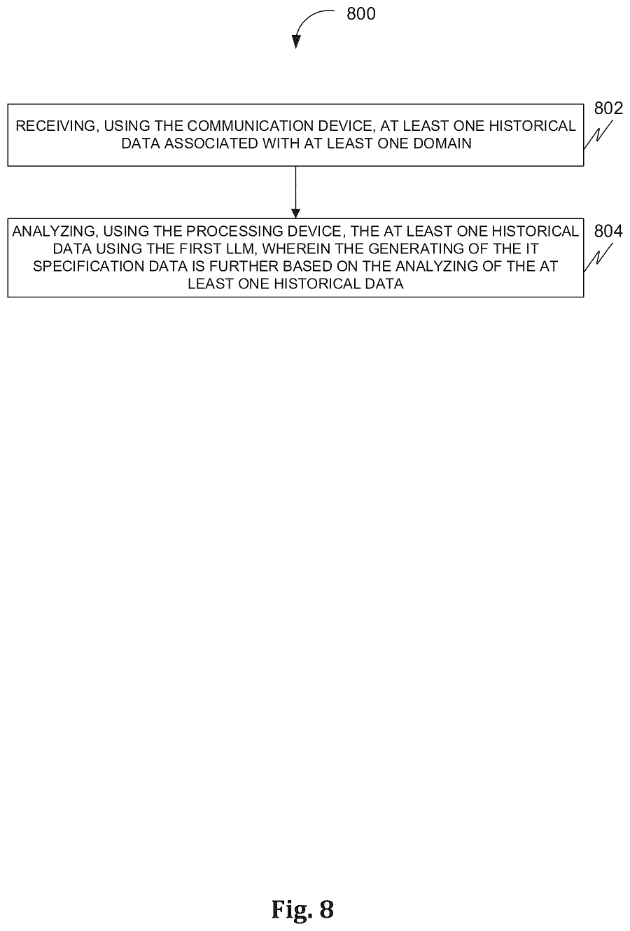

FIG. 8 illustrates a flowchart of a method 800 of facilitating provisioning of information technology infrastructure data including analyzing, using the processing device 504, the at least one historical data using the first LLM, in accordance with some embodiments. For example, the at least one historical data may be associated with the at least one infrastructure, such as for example, a legacy system. In an instance, the at least one historical data may correspond to one or more maintenance logs representing maintenance activities carried out on the at least one infrastructure. Such maintenance activities may include updating one or more of a software, a firmware, a hardware, a configuration, an architecture, a business logic, a workflow and a data-structure associated with the at least one infrastructure. In another instance, the at least one historical data may include ticket data presenting one or more technical issues associated with the at least one infrastructure. In yet another instance, the at least one historical data may include diagnostic data presenting a result of a diagnosis performed on the at least one infrastructure.

Further, in some embodiments, the method 800 further may include a step 802 of receiving, using the communication device 502, one or more historical data associated with one or more domains. Further, in some embodiments, the method 800 further may include a step 804 of analyzing, using the processing device 504, the one or more historical data using the first LLM. Further, the generating of the IT specification data may be further based on the analyzing of the one or more historical data.

In some embodiments, the one or more IT infrastructures includes one or more legacy IT infrastructures.

In some embodiments, the updated IT infrastructure data corresponds to a modern IT infrastructure.

In some embodiments, the updated IT infrastructure includes a modern IT platform.

In some embodiments, the first LLM model includes a domain adaptive LLM. Further, the training may be based on each of the concept data, the workflow data and the computational logic data associated with a domain.

In some embodiments, the training may be based on one or more autonomous learning algorithms.

In some embodiments, the one or more autonomous learning algorithms may be configured for eliminating manual intervention.

In some embodiments, the fine-tuning includes a self-optimization of the first LLM.

In some embodiments, the IT infrastructure data corresponds to one or more of a hardware, a software and a firmware.

In some embodiments, the hardware includes a computing hardware, a storage hardware and a networking hardware.

In some embodiments, the method 300 may further include collecting, using one or more data ingestion tools, the training data.

In some embodiments, the one or more data ingestion tools may be configured for collecting the training data from one or more data sources.

In some embodiments, the training includes utilizing one or more proprietary tools for comprehending one or more of the concept data, the computational logic data and the workflow data.

In some embodiments, the training of the first LLM using the one or more feedback data includes a dynamic feedback looping.

In some embodiments, the IT specification data may be used for implementing the one or more IT infrastructures.

In some embodiments, the training data may be comprised in a code.

In some embodiments, the one or more properties includes a size of a file associated with one or more of the concept data, the workflow data and the computational logic data.

In some embodiments, the one or more utilization data represents a usage of the GPU.

In some embodiments, the one or more functionalities includes performing a software operation.

In some embodiments, the IT specification data includes one or more recommendations for modernizing one or more legacy systems.

In some embodiments, the one or more IT infrastructure data may be collected from one or more data ingestion tools.

In some embodiments, the one or more IT specification data corresponds to the domain.

In some embodiments, the updated IT infrastructure data corresponds to one or more of a healthcare software, a financial software and an enterprise software.

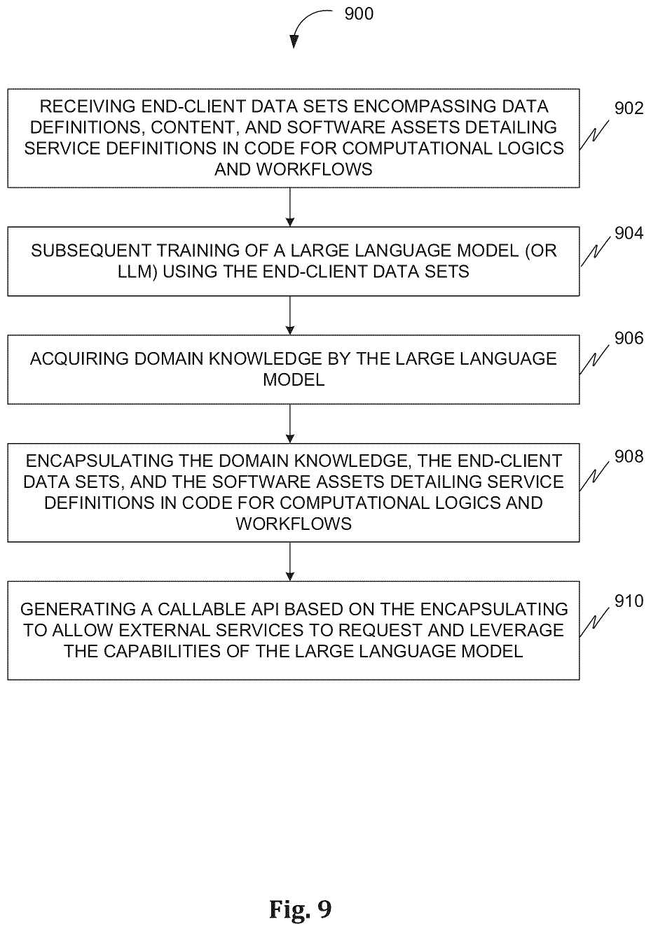

FIG. 9 is a flowchart of a method 900 for facilitating transformations of large language models for generating domain-specialized outputs, in accordance with some embodiments.

Further, the method may include a step 902 of receiving end-client data sets encompassing data definitions, content, and software assets detailing service definitions in code for computational logics and workflows.

Further, the method may include a step 904 of subsequent training of a large language model (or LLM) using the end-client data sets.

Further, the method may include a step 906 of acquiring domain knowledge by the large language model.

Further, the method may include a step 908 of encapsulating the domain knowledge, the end-client data sets, and the software assets detailing service definitions in code for computational logics and workflows.

Further, the method may include a step 910 of generating a callable API based on the encapsulating to allow external services to request and leverage the capabilities of the large language model.

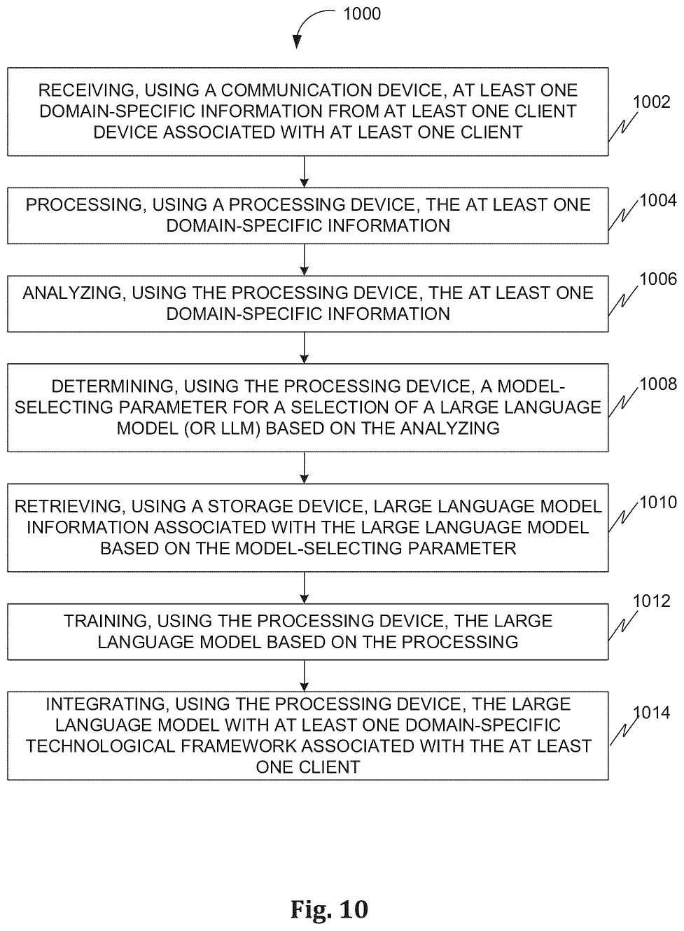

FIG. 10 is a flowchart of a method 1000 for facilitating transformations of large language models for generating domain-specialized outputs, in accordance with some embodiments.

Further, the method may include a step 1002 of receiving, using a communication device, at least one domain-specific information from at least one client device associated with at least one client. Further, the at least one client device may include, but may not be limited to, a smartphone, a laptop, a desktop, a server, etc.

Further, the method may include a step 1004 of processing, using a processing device, the at least one domain-specific information.

Further, the method may include a step 1006 of analyzing, using the processing device, the at least one domain-specific information.

Further, the method may include a step 1008 of determining, using the processing device, a model-selecting parameter for a selection of a large language model (or LLM) based on the analyzing.

Further, the method may include a step of retrieving 1010, using a storage device, a large language model information associated with the large language model based on the model-selecting parameter. Further, the large language model may be pre-trained on a broad spectrum of data.

Further, the method may include a step 1012 of training, using the processing device, the large language model based on the processing. Further, the training may include at least one transformation of the large language model to render the large language model to generate a plurality of domain-specific outputs.

Further, the method may include a step 1014 of integrating, using the processing device, the large language model with at least one domain-specific technological framework associated with the at least one client.

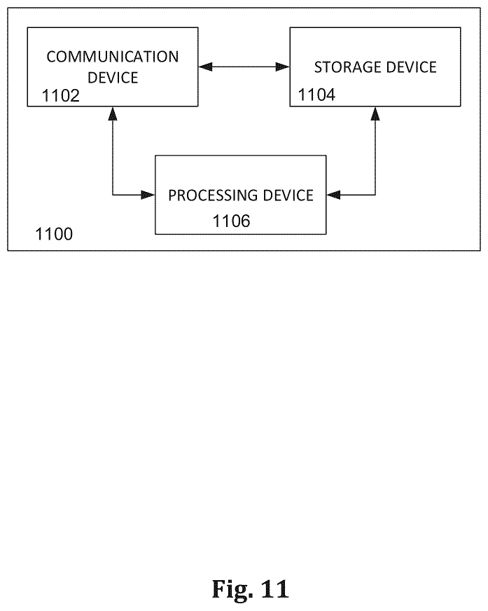

FIG. 11 is a block diagram of a system 1100 for facilitating transformations of large language models for generating domain-specialized outputs, in accordance with some embodiments. Accordingly, the system 1100 may include a processing device 1106, a communication device 1102, and a storage device 1104. Further, the communication device 1102 may be communicatively coupled with the processing device 1106. Further, the communication device 1102 may be communicatively coupled with the storage device 1104. Further, the storage device 1104 may be communicatively coupled with the processing device 1106.

Further, the communication device 1102 may be configured for receiving at least one domain-specific information from at least one client device associated with at least one client. Further, the at least one client device may include, but may not be limited to, a smartphone, a laptop, a desktop, a server, etc.

Further, the processing device 1106 may be configured for processing the at least one domain-specific information. Further, the processing device 1106 may be configured for analyzing the at least one domain-specific information. Further, the processing device 1106 may be configured for determining a model-selecting parameter for a selection of a large language model (or LLM) based on the analyzing. Further, the processing device 1106 may be configured for training the large language model based on the processing. Further, the training may include at least one transformation of the large language model to render the large language model to generate a plurality of domain-specific outputs. Further, the processing device 1106 may be configured for integrating the large language model with at least one domain-specific technological framework associated with the at least one client.

Further, the storage device 1104 may be configured for retrieving the large language model information associated with the large language model based on the model-selecting parameter. Further, the large language model may be pre-trained on a broad spectrum of data.

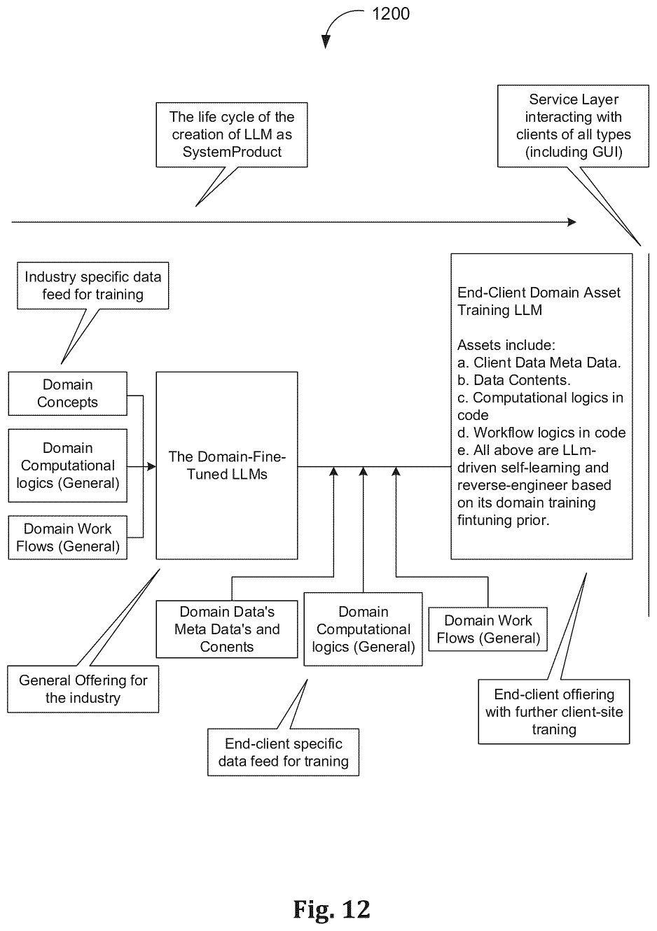

FIG. 12 is a flow diagram associated with a system 1200 for facilitating transformations of large language models for generating domain-specialized outputs, in accordance with some embodiments.

Although the invention has been explained in relation to its preferred embodiment, it is to be understood that many other possible modifications and variations may be made without departing from the spirit and scope of the invention as hereinafter claimed.

### Aspects

1. A method for generating and modernizing domain-specific platforms using a domain-trained large language model, the method comprising ingesting domain-specific data, formulating computational workflows, and continuously updating based on real-time feedback.
2. The method of aspect 1, wherein the large language model autonomously self-optimizes without manual intervention.
3. The method of aspect 1, wherein the system reduces computational inefficiencies and accelerates the modernization process.
4. A system for domain-specific platform generation, the system comprising a fine-tuned large language model, domain-specific data ingestion tools, and autonomous learning algorithms.

What is claimed is:

1. A method of facilitating provisioning of Information Technology (IT) infrastructure data, the method comprising:
receiving, using a communication device, at least one IT infrastructure data associated with at least one IT infrastructure from a client device;
analyzing, using a processing device, the at least one IT infrastructure data using a first Large Language Model, wherein the first LLM is trained on a training data comprising an association of a plurality of IT infrastructure data and a plurality of IT specification data;
generating, using the processing device, at least one IT specification data based on the analyzing, wherein the at least one IT specification data comprises a functionality data representing at least one functionality provided by the at least one IT infrastructure implemented according to the at least one IT specification data; and
transmitting, using the communication device, the at least one IT specification data to the client device.

2. The method of claim 1 further comprising generating, using the processing device, an updated IT infrastructure data based on the at least one IT specification data, wherein the generating of the updated IT infrastructure data is performed using a second LLM.

3. The method of claim 1 further comprising training, using the processing device, the first LLM based on the training data.

4. The method of claim 1, wherein the training data comprises at least one of a concept data, a workflow data and a computational logic data.

5. The method of claim 1, wherein the training data corresponds to a domain.

6. The method of claim 2, further comprising deploying, using the processing device, an updated IT infrastructure based on the updated IT infrastructure data.

7. The method of claim 1 further comprising receiving, using the communication device, at least one feedback data from the client device, wherein the feedback data comprises at least one feedback based on the at least one IT specification data, wherein the analyzing of the at least one IT infrastructure data is based on the training of the first LLM using the at least one feedback data.

8. The method of claim 4, wherein the training of the first LLM comprises embedding at least one vector representation of at least one of the concept data, the computational logic data and the workflow data into a model architecture of the first large language model.

9. The method of claim 8, wherein the training further comprises fine-tuning of the first LLM based on the embedding.

10. The method of claim 1, wherein the training data corresponds to a domain, wherein the method further comprises:
generating, using the processing device, a user interface data corresponding to a user interface configured to receive indication of the training data; and
transmitting, using the communication device, the user interface data to the client device.

11. A system for facilitating provisioning of Information Technology (IT) infrastructure data, the system comprising:
a communication device configured for:
receiving at least one IT infrastructure data associated with at least one IT infrastructure from a client device; and
transmitting at least one IT specification data to the client device;
a processing device configured for:
analyzing the at least one infrastructure data using a first Large Language Model, wherein the first LLM is trained on a training data comprising an association of a plurality of IT infrastructure data and a plurality of IT specification data; and
generating the at least one IT specification data based on the analyzing, wherein the at least one IT specification data comprises a functionality data representing at least one functionality provided by the at least one IT infrastructure implemented according to the at least one IT specification data.

12. The system of claim 11, wherein the processing device is further configured for generating an updated IT infrastructure data based on the at least one IT specification data using a second LLM.

13. The system of claim 11, wherein the processing device is further configured for training the first LLM based on the training data.

14. The system of claim 11, wherein the training data comprises at least one of a concept data, a workflow data and a computational logic data.

15. The system of claim 11, wherein the training data corresponds to a domain.

16. The system of claim 12, wherein the processing device is further configured for deploying an updated IT infrastructure based on the updated IT infrastructure data.

17. The system of claim 11, wherein the communication device is further configured for receiving at least one feedback data from the client device, wherein the feedback data comprises at least one feedback based on the at least one IT specification data, wherein the processing device is further configured for analyzing the at least one IT infrastructure data based on the training of the first LLM using the at least one feedback data.

18. The system of claim 14, wherein the training of the first LLM comprises embedding at least one vector representation of at least one of the concept data, the computational logic data and the workflow data into a model architecture of the first large language model.

19. The system of claim 18, wherein the training further comprises fine-tuning of the first LLM based on the embedding.

20. The system of claim 11, wherein the training data corresponds to a domain, wherein the processing device is further configured for generating a user interface data corresponding to a user interface configured to receive indication of the training data, wherein the communication device is further configured for transmitting the user interface data to the client device.
